(19) United States
(12) Patent Application Publication
(10) Pub. No.: US 2021/0397198 A1
(43) Pub. Date: Dec. 23, 2021

(54) ENHANCED VEHICLE OPERATION

(71) Applicant: Ford Global Technologies, LLC, Dearborn, MI (US)

(72) Inventors: Iman Soltani Bozchalooi, Sacramento, CA (US); Francois Charette, Tracy, CA (US); Praveen Narayanan, San Jose, CA (US); Ryan Burke, Palo Alto, CA (US); Devesh Upadhyay, Canton, MI (US); Dimitar Petrov Filev, Novi, MI (US)

(73) Assignee: Ford Global Technologies, LLC, Dearborn, MI (US)

(21) Appl. No.: 16/904,653

(22) Filed: Jun. 18, 2020

(51) Int. Cl. G05D 1/02; G06K 9/00; G06K 9/62; G01C 21/36; G01C 21/34; G06N 20/00; G06F 17/18

(52) U.S. Cl. CPC G05D 1/0246; G06K 9/00791; G06K 9/6215; G06K 9/6256; G01C 21/3679; G05D 1/0287; G05D 1/0212; G01C 21/3644; G06N 20/00; G06F 17/18; G01C 21/3407

(57) ABSTRACT

A computer includes a processor and a memory storing instructions executable by the processor to receive an image including a physical landmark, output a plurality of synthetic images, wherein each synthetic image is generated by simulating at least one ambient feature in the received image, generate respective feature vectors for each of the plurality of synthetic images, and actuate one or more vehicle components upon identifying the physical landmark in a second received image based on a similarity measure between the feature vectors of the synthetic images and a feature vector of the second received image, the similarity measure being one of a probability distribution difference or a statistical distance.

### BACKGROUND

Vehicles can be equipped with computing devices, networks, sensors and controllers to acquire data regarding the vehicle's environment and to operate the vehicle based on the data. Vehicle sensors can provide data concerning routes to be traveled and objects to be avoided in the vehicle's environment. Operation of the vehicle can rely upon acquiring accurate and timely data regarding objects in a vehicle's environment while the vehicle is being operated on a roadway. Vehicles may use neural networks to identify objects from image data collected by the vehicle sensors.

### BRIEF DESCRIPTION OF THE DRAWINGS

FIG. 1 is a diagram of an example system for operating a vehicle.

FIG. 2 is a diagram of an example server storing identified landmarks.

FIG. 3 is a diagram of an example process for identifying and storing the landmarks in the example server.

FIG. 4 is a diagram an example machine learning program.

FIG. 5 is a top-down view of the vehicle traveling along a route.

FIG. 6 is a diagram of an example process for identifying and storing the landmarks.

FIG. 7 is a diagram of an example process for identifying a landmark in a collected image.

### DETAILED DESCRIPTION

A system includes a computer including a processor and a memory, the memory storing instructions executable by the processor to receive an image including a physical landmark, output a plurality of synthetic images, wherein each synthetic image is generated by simulating at least one ambient feature in the received image, generate respective feature vectors for each of the plurality of synthetic images, and actuate one or more vehicle components upon identifying the physical landmark in a second received image based on a similarity measure between the feature vectors of the synthetic images and a feature vector of the second received image, the similarity measure being one of a probability distribution difference or a statistical distance.

The instructions can further include instructions to generate a route for a vehicle, to identify one or more physical landmarks along the route, and to plan actuation of the one or more vehicle components based on the identified one or more physical landmarks.

The instructions can further include instructions to, while the vehicle is traveling along the route, collect the second received image with a camera, to identify the physical landmark in the second received image, and to actuate the one or more vehicle components based on the planned actuation based on the identified one or more physical landmarks.

The instructions can further include instructions to assign a maneuver to each identified physical landmark on the route, the maneuver being one of a left turn, a right turn, or a straight path.

The instructions can further include instructions to identify a plurality of feature vectors associated with the physical landmark, and to identify the similarity measure of the feature vectors.

The instructions can further include instructions to identify the physical landmark when the similarity measure of a first plurality of the feature vectors is above a threshold and to identify a second physical landmark based when the similarity measure of a second plurality of the feature vectors is above the threshold.

The instructions can further include instructions to identify a similarity measure between a mean feature vector of the synthetic images and feature vectors of a plurality of received images and to identify the physical landmark when the similarity measure is above a threshold.

The statistical distance can be a Mahalanobis distance.

The probability distribution difference can be a KL divergence.

The ambient feature can be one of an insolation, precipitation, cloudiness, an amount of traffic, or a change in viewing angle.

The instructions can further include instructions to generate a covariance matrix of the feature vectors of the plurality of synthetic images, to generate an inverse covariance matrix that is a matrix inverse of the covariance matrix, and to determine the similarity measure based on at least one of the covariance matrix or the inverse covariance matrix.

The instructions can instructions further include instructions to generate the feature vectors of the plurality of synthetic images with a machine learning program.

A method includes receiving an image including a physical landmark, outputting a plurality of synthetic images, wherein each synthetic image is generated by simulating at least one ambient feature in the received image, generating respective feature vectors for each of the plurality of synthetic images, and actuating one or more vehicle components upon identifying the physical landmark in a second received image based on a similarity measure between the feature vectors of the synthetic images and a feature vector of the second received image, the similarity measure being one of a probability distribution difference or a statistical distance

The method can further include generating a route for a vehicle, identifying one or more physical landmarks along the route, and planning actuation of the one or more vehicle components based on the identified one or more physical landmarks.

The method can further include, while the vehicle is traveling along the route, collecting the second received image with a camera, identifying the physical landmark in the second received image, and actuating the one or more vehicle components based on the planned actuation based on the identified one or more physical landmarks.

The method can further include assigning a maneuver to each identified physical landmark on the route, the maneuver being one of a left turn, a right turn, or a straight path.

The method can further include identifying a plurality of feature vectors associated with the physical landmark and identifying the similarity measure of the feature vectors.

The method can further include identifying the physical landmark when the similarity measure of a first plurality of the feature vectors is above a threshold and identifying a second physical landmark based when the similarity measure of a second plurality of the feature vectors is above the threshold.

The method can further include identifying a similarity measure between a mean feature vector of the synthetic images and feature vectors of a plurality of received images and identifying the physical landmark when the similarity measure is above a threshold.

The method can further include generating a covariance matrix of the feature vectors of the plurality of synthetic images, generating an inverse covariance matrix that is a matrix inverse of the covariance matrix, and determining the similarity measure based on at least one of the covariance matrix or the inverse covariance matrix.

The method can further include generating the feature vectors of the plurality of synthetic images with a machine learning program.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

A vehicle can actuate a sensor to collect images while vehicle is traveling along a route. Physical landmarks can be identified along the route prior to embarking on the route. By identifying a physical landmark in the images along the route, a vehicle computer can determine a location of the vehicle along the route without geo-coordinate data from an external server. That is, the vehicle computer can assign actuation of specific vehicle components to the portion of the route at which the landmark is located, and upon identifying the landmark, the vehicle computer can perform the assigned actuation. Thus, the vehicle computer can navigate the vehicle along the route without additional geo-coordinate data by actuating components according to identified landmarks along the route.

A machine learning program, e.g., a neural network, can be trained to identify the landmark. The machine learning program can be trained to generate data identifying the landmark for a memory allocation of an external server. The machine learning program can generate a reference feature vector from reference images that identify the landmark. Upon collecting an image along the route, the vehicle computer can input the image to the machine learning program and compare the output feature vector to the reference feature vector collected in advance in a memory. Based on a similarity measure, such as a statistical distance or a probability distribution difference, between the output feature vector and the reference feature vector, the vehicle computer can identify the landmark.

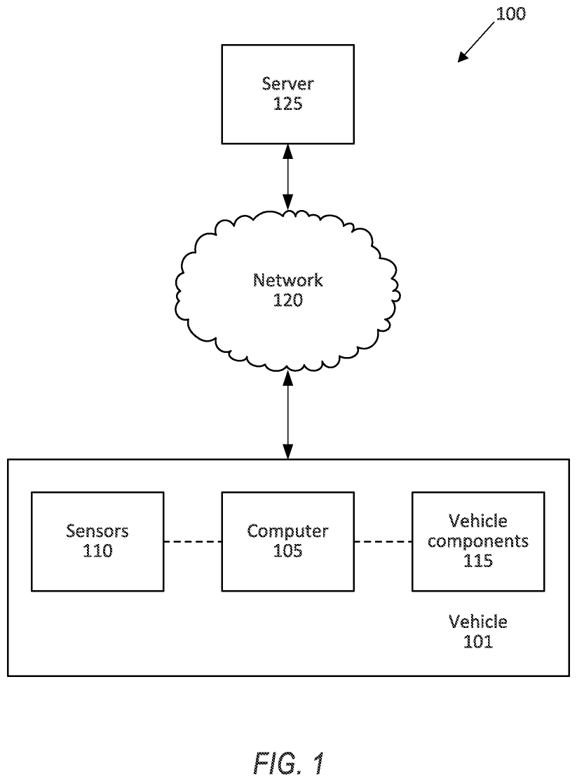

FIG. 1 illustrates an example system 100 for operating a vehicle 101. A computer 105 in the vehicle 101 is programmed to receive collected data from one or more sensors 110. For example, vehicle 101 data may include a location of the vehicle 101, data about an environment around a vehicle, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data can include measurements of vehicle 101 systems and components, e.g., a vehicle 101 velocity, a vehicle 101 trajectory, etc.

The computer 105 is generally programmed for communications on a vehicle 101 network, e.g., including a conventional vehicle 101 communications bus such as a CAN bus, LIN bus, etc., and or other wired and/or wireless technologies, e.g., Ethernet, WIFI, etc. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, sensors, etc., including sensors 110. Alternatively or additionally, in cases where the computer 105 actually comprises multiple devices, the vehicle network may be used for communications between devices represented as the computer 105 in this disclosure. For example, the computer 105 can be a generic computer with a processor and memory as described above and/or may include a dedicated electronic circuit including an ASIC that is manufactured for a particular operation, e.g., an ASIC for processing sensor data and/or communicating the sensor data. In another example, computer 105 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 105.

In addition, the computer 105 may be programmed for communicating with the network 120, which, as described below, may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 110. The memory can be a separate device from the computer 105, and the computer 105 can retrieve information stored by the memory via a network in the vehicle 101, e.g., over a CAN bus, a wireless network, etc. Alternatively or additionally, the memory can be part of the computer 105, e.g., as a memory of the computer 105.

Sensors 110 can include a variety of devices. For example, various controllers in a vehicle 101 may operate as sensors 110 to provide data via the vehicle 101 network or bus, e.g., data relating to vehicle speed, acceleration, location, subsystem and/or component status, etc. Further, other sensors 110 could include cameras, motion detectors, etc., i.e., sensors 110 to provide data for evaluating a position of a component, evaluating a slope of a roadway, etc. The sensors 110 could, without limitation, also include short range radar, long range radar, LIDAR, and/or ultrasonic transducers.

Collected data can include a variety of data collected in a vehicle 101. Examples of collected data are provided above, and moreover, data are generally collected using one or more sensors 110, and may additionally include data calculated therefrom in the computer 105, and/or at the server 125. In general, collected data may include any data that may be gathered by the sensors 110 and/or computed from such data.

The vehicle 101 can include a plurality of vehicle components 115. In this context, each vehicle component 115 includes one or more hardware components adapted to perform a mechanical function or operation—such as moving the vehicle 101, slowing or stopping the vehicle 101, steering the vehicle 101, etc. Non-limiting examples of components 115 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like. Components 115 can include computing devices, e.g., electronic control units (ECUs) or the like and/or computing devices such as described above with respect to the computer 105, and that likewise communicate via a vehicle 101 network.

For purposes of this disclosure, the term “autonomous vehicle” refers to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computer 105. A semi-autonomous mode is one in which at least one of vehicle 101 propulsion (typically via a powertrain including an electric motor and/or internal combustion engine), braking, and steering are controlled at least partly by the computer 105 as opposed to a human operator. In a non-autonomous mode, i.e., a manual mode, the vehicle 101 propulsion, braking, and steering are controlled by the human operator.

The system 100 can further include a network 120 connected to a server 125. The computer 105 can further be programmed to communicate with one or more remote sites such as the server 125, via the network 120, such remote site possibly including a processor and a memory. The network 120 represents one or more mechanisms by which a vehicle computer 105 may communicate with a remote server 125. Accordingly, the network 120 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

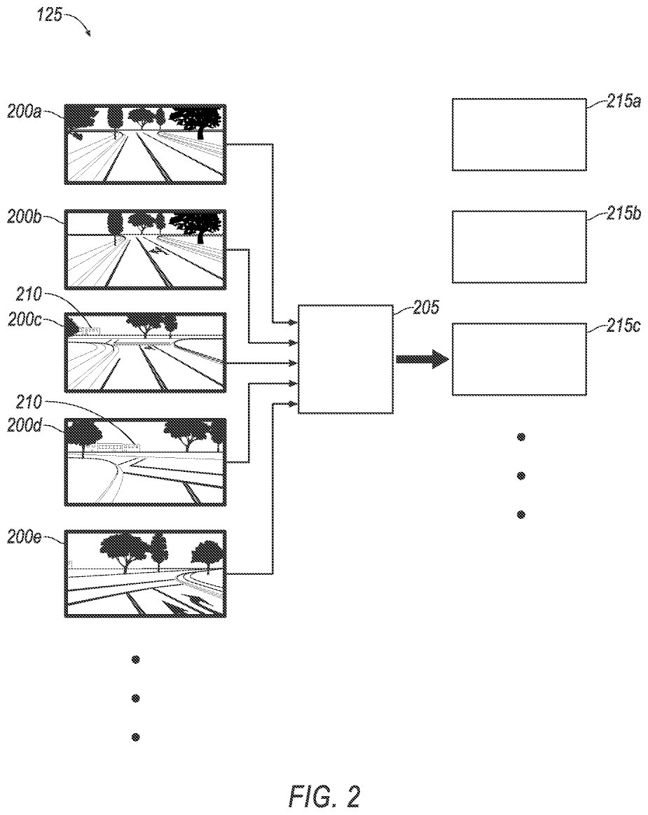

FIG. 2 is a diagram of images 200 input to a machine learning program 205 to generate stored landmarks 210 for a plurality of roadways. FIG. 2 shows five images, 200a, 200b, 200c, 200d, and 200e, collectively, “images 200.” The images 200 include one or more landmarks 210. In this context, a “landmark” is a physical object on or near a roadway. The landmark can be, e.g., an infrastructure element such as a bridge or a utility pole, a building, a work of public art, etc. FIG. 2 shows one landmark 210 in the images 200c, 200d. By identifying the landmarks 210, the computer 105 can actuate one or more components 115 of the vehicle 101 to follow a route, as described below.

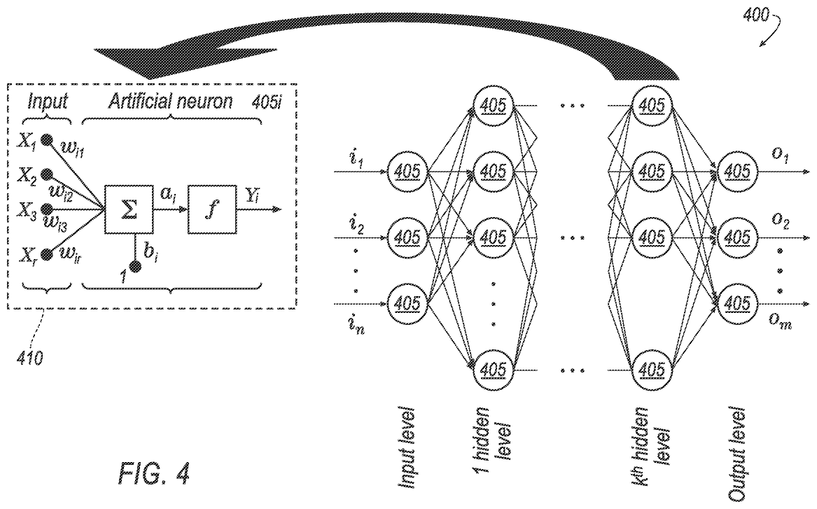

The server 125 can input the images to the machine learning program 205. The machine learning program 205 can be a deep neural network (DNN), described below and best shown in FIG. 4. Alternatively, the machine learning program 205 can be, e.g., a convolutional neural network (CNN), a gradient boosted tree algorithm, etc. Using a machine learning program 205 allows the computer 105 of the vehicle 101 to identify the landmarks 210 without conventional image processing techniques (such as Canny edge detection) and/or without collecting geo-location data while the vehicle 101 is moving along a route. That is, the computer 105 can use the machine learning program 205 to identify the landmarks 210 with less computing resources than conventional image processing techniques and can identify the landmarks 210 when geo-location data is not available.

The server 125 can store landmarks 210 to be identified by a computer 105 of a vehicle 101. Inputting the images 200 for a specified location, e.g., an intersection, to the machine learning program 205 to identify the landmarks 210 at the location. The server 125 can assign each location to a specific memory allocation 215. A “memory allocation” in the present context is an amount of hard drive space of the server 125 assigned to store data describing a specific landmark 210 and a location (e.g., a memory address) from which the server 125 can locate the data describing the specific landmark 210. FIG. 2 shows three memory allocations 215a, 215b, 215c, collectively, memory allocations 215. The server 125 can include a specified memory allocation 215 for each identified landmark 210. The server 125 can transmit data from the memory allocation 215 over the network 120 to the computer 105 of the vehicle 101. Alternatively or additionally, the computer 105 can identify the landmarks 210 and store the data in a memory allocation 215 of a memory of the computer 105.

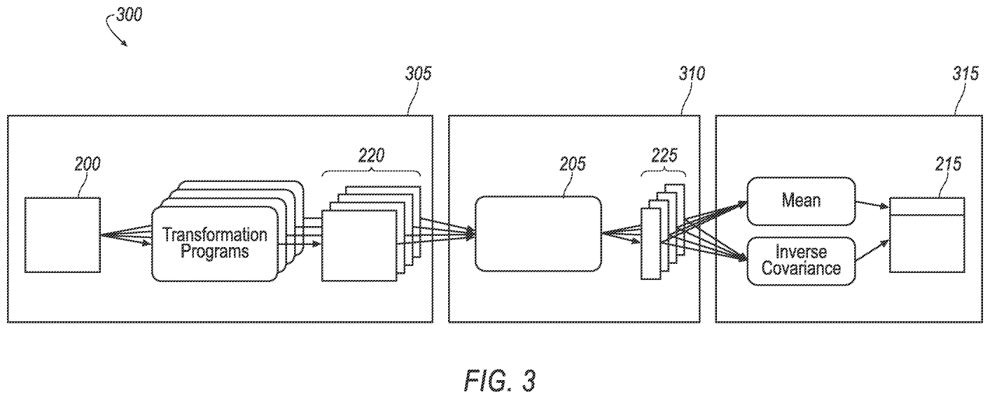

FIG. 3 is a diagram of an example process 300 for generating a memory allocation 215 storing an identification of a landmark 210. The process 300 begins in a block 305, in which a reference image 200 is input into a plurality of transformation programs, each transformation program generating a synthetic image 220 that is the reference image 200 with an ambient feature incorporated. An “ambient feature” is a modification to an image 200 to include a specific environmental attribute (e.g., increased lighting, decreased lighting, increased contrast, decreased contrast, precipitation, cloudiness, insolation, plant color, season, etc.) and/or to change a view of objects in the image 200 (e.g., decreasing a size of an object, changing an angle of view of the object, increasing the size of the object, etc.) and/or other objects in the image 200 (e.g., an amount of traffic). That is, the ambient features can provide environmental and scenario variations to the reference image 200 that may not have been collected by camera collecting the reference image 200. Incorporating ambient features to the reference image 200 allows synthetic images 220 to show scenarios and environmental effects that can be difficult to collect because of occlusion by precipitation or because the desired environmental feature does not occur during collection of the reference image 200. For example, the reference image 200 may have been collected during daylight in spring, when collecting images 200 is easier than collecting images at night in winter, which may occlude objects from the camera collecting the reference image 200. A “transformation program” is an algorithm, e.g., implemented in the server 125 and/or the computer 105, that generates a synthetic image 200 by inserting the ambient feature into a copy of the reference image 200. The transformation programs can be, e.g., unsupervised image-to-image translation algorithms, image processing algorithms that adjust color values of pixels in the reference image 200, variational autoencoder algorithms, generative adversarial networks, etc.

The transformation program include a generative adversarial network (GAN). Image data output from a photorealistic rendering software program can be input to a GAN to generate images in the data set of training images corresponding to underrepresented noise characteristics. A GAN is a neural network that includes a generative network that modifies input images and a discriminator network that is trained to determine whether a modified image is similar to a real image. Image similarity can be determined by comparing images using image subtraction, where a first image is subtracted from a second image and the absolute or squared differences between the two images are summed. Small absolute or squared differences (<1% of total summed pixel values) indicate similar images. Image similarity can also be determined based on correlation techniques that correlate regions of a first image with regions of a second image. High correlation (>90%) between the two images indicate similar images. The GAN is trained to modify input synthetic images realistically enough to be determined as “real” by the discriminator network. A generative adversarial network can be trained to modify an input image to simulate the effects of different noise characteristics. For example, a GAN can be trained to modify a synthetic image of a trailer rendered in full sunlight to appear as if it was raining when the photorealistic image was generated. The GAN can be trained to produce output images with a specified level of noise. For example, a GAN can produce an output image with an ambient feature such as low, medium, or high amounts of rainfall.

The transformation program can include a variable autoencoder (VAE). A VAE includes a policy optimization network to generate a reconstructed policy from a vehicle state by combining a latent reward function based on a prior experience expert policy, and an adversarial discriminator network to discriminate the reconstructed policy and expert policy. VAEs solve the problem of underdetermined equations by generating a plurality of reconstructed policies distributed over the solution space of reconstructed policies and determining which reconstructed policies of the plurality of reconstructed policies match expert policies. Techniques described herein use an adversarial process including a discriminator network to determine if a policy generated by an encoder neural network is an expert policy. Using an adversarial process, a transformation program can be trained to generate reconstructed policies that are generally indistinguishable from expert policies.

A VAE/GAN transformation program can generate synthetic images 220 from the reference image 200 by encoding the reference image 200 with the VAE to incorporate an ambient feature and using a discriminator from the GAN to output the synthetic image 220 with the ambient feature incorporated. Using a VAE/GAN hybrid program to generate the synthetic image 220 can reduce blurriness in the synthetic images 220 compared to synthetic images 220 generated from a VAE or a GAN alone. That is, VAEs can be easy to train, but output from the VAE can be blurry compared to a reference image. A GAN can output synthetic images 220 much closer to the reference image 200 than VAEs, but GANs can be difficult to train. Using a VAE to generate an intermediate image and a GAN to reduce the blurriness of the intermediate image can output a synthetic image 220 that is less blurry than output from either the VAE or the GAN alone.

Next, in a block 310, the server 125 and/or the computer 105 inputs the synthetic images 220 to a machine learning program 205 to train the machine learning program 205. As described further below, the synthetic images 220 can include annotations of landmarks 210, and the machine learning program 205 can learn the identification of the landmarks 210 from the annotations. The machine learning program 205 can output a plurality of feature vectors 225 of the synthetic images 220. A “feature vector” is a 1-dimensional array of values that encode information from the 2-dimensional synthetic image 220. Each value of the feature vector 225 identifies a characteristic of a pixel or a group of neighboring pixels of the synthetic image 220, e.g., an intensity, an RGB value, a gradient magnitude, an indicator that the pixel is or is not at an edge of an object, etc. Each value may quantify a characteristic of the synthetic image 220, e.g., the existence and intensity of objects with circular shape, objects with sharp edges, etc.

Next, in a block 315, the server 125 and/or the computer 105 identifies a mean feature vector 225 and an inverse covariance matrix of the feature vectors 225. The server 125 and/or the computer 105 can store the set mean and the inverse covariance matrix of the identified landmark 210 in the memory allocation 215.

Upon generating the memory allocations 215 for the landmarks 210, the computer 105 can identify a landmark 210 in an input image 200 by determining a similarity measure between the input image 200 and the landmark 210. In this context, a “similarity measure” is a measure of a difference between two feature vectors 225 in a set of a plurality of feature vectors 225. One example of a similarity measure is a statistical distance, e.g., a Mahalanobis distance. A “statistical distance” is a distance between two points relative to an overall mean of a plurality of data points. In this context, the statistical distance is a value that represents how values of a given feature vector 225 differ from a mean feature vector 225, i.e., an arithmetic mean of the plurality of feature vectors 225. The server 125 and/or the computer 105 can identify the statistical distance between feature vectors 225 of the synthetic images 220 and/or the images 200.

For example, the statistical distance can be a Mahalanobis distance d:

d(\vec{x})=\sqrt{(\vec{x}−\vec{y})^{T}S⁻¹(\vec{x}−\vec{y})} (1)

where a first vector \vec{x}=[x₁, x₂ . . . xₙ]^{T}, each xᵢ, i∈[1, n] being one of a first set of n feature vectors 225 in a first set of images 200, 220, e.g., the images 200, 220 used to generate the memory allocation 215 described above. A second vector \vec{y}=[y₁, y₂ . . . yₙ]^{T}, each yᵢ, i∈[1, n] being one of a second set of n feature vectors 225 in a second set of images 200, 220, e.g., collected by a sensor 110 of the vehicle 101. S⁻¹ is an inverse covariance matrix, as described below, and T is a matrix transposition function. S is a covariance matrix, i.e., a matrix in which each element S(i,j) (i,j∈[1, n]) is the covariance of values xᵢ and yⱼ. That is, the covariance of two variables a, b having average values ā, b̅ is cov(a, b)=E[(a−ā)(b−b̅)]=σ_{ab}², where E is the conventional expected value function that outputs an expected value, i.e., probability-weighted sums of a variable a provided states b, and σ_{ab} is the standard deviation of a, b. The inverse covariance matrix S⁻¹ is the mathematical inverse of the covariance matrix S. Thus, the server 125 can determine the Mahalanobis distance d between each feature vector 225 in the first set of images 200, 220 and each feature vector 225 in the second set of images 200, 220.

Using the Mahalanobis distance d, the computer 105 can determine whether a feature vector 225 of an input image 200 includes a landmark 210. The computer 105 can collect a plurality of images 200 with a camera 110 while the vehicle 101 is traveling on a roadway. The computer 105 can generate a plurality of synthetic images 220 by applying the transformation programs described above to the collected images 220 and can determine a mean feature vector 225 of the images 200, 220. The computer 105 can determine the Mahalanobis distance d between the mean feature vector 225 of the images 200, 220 and the inverse covariance matrix S⁻¹ of the landmark 210 stored in the memory allocation 215. That is, in Equation 1 above, the feature vectors 225 of the images 200, 220 can be the first vector \vec{x}, the mean feature vector 225 from the memory allocation 215 can be the second vector \vec{y}, and the computer 105 can determine the Mahalanobis distance with the inverse covariance matrix S⁻¹ in the memory allocation 215. Determining the Mahalanobis distance of the mean feature vector 225 of images 200, 220 with the inverse covariance matrix S⁻¹ in the memory allocation is a “forward” Mahalanobis distance d_{f}. The computer 105 can determine a “reverse” Mahalanobis distance dᵣ between the mean feature vector 225 of the landmark 210 stored in the memory allocation 215 and an inverse covariance matrix S₀⁻¹, the covariance matrix S₀ being the matrix in which each element is the covariance of the images 200, 220 generated from the collected images 200. With the forward and reverse Mahalanobis distances d_{f}, dᵣ, the computer 105 can identify the landmark 210 in the collected images 200, as described below.

Using the Mahalanobis distance to identify the landmark 210 can provide a more accurate identification of the landmark 210 than a Euclidian distance (i.e., a straight line distance) because the Mahalanobis distance accounts for the covariance and/or correlation between the feature vector 225 of the input image 200 and the feature vectors 225 used to generate the mean feature vector 225 and the inverse covariance matrix S⁻¹. That is, A Euclidian distance between two feature vectors 225 may provide a false positive identification of the landmark 210 because the feature vectors 225 can be close in Euclidian distance but are not part of the same landmark 210. The Mahalanobis distance is greater than the Euclidian distance for two feature vectors 225 of different landmarks 210 because those feature vectors 225 would be farther from their respective mean feature vectors 225 than each other, further normalized by the expected variances of the features. Thus, the Mahalanobis distance between feature vectors 225 of an input image 200 and the feature vectors 225 used to generate the mean feature vector 225 and inverse covariance matrix S⁻¹ of the memory allocation can better identify landmarks 210 than the Euclidian distance between those feature vectors 225.

Another example of a similarity measure is a probability distribution difference. A “probability distribution difference” is a measure of how a first probability distribution differs from a second probability distribution. The probability distribution difference can be a Kullback-Leibler (KL) divergence D_{KL} of a first set P of n feature vectors 225 and a second set Q of n feature vectors 225, assuming Gaussian distributions:

$${D}_{K L} ( P ‖ Q ) = \frac{1}{2} t r ( {S}_{1}^{- 1} {S}_{0} ) + n + ln ( \frac{det ( {S}_{1} )}{det ( {S}_{0} )} ) \qquad ( 2 )$$

where tr( ) is the trace function that sums the diagonal elements of a square matrix, det( ) is the determinant of a matrix, S₀ is the covariance matrix of one or more images 200 collected by a sensor 110 of the vehicle 101, S₁ is the covariance matrix of the memory 215 of the landmark 210, and n is the length of the feature vectors 225 used to determine the covariance matrix S₁.

In calculation of the KL divergence the probability distributions of the sets P, Q are assumed to be Gaussian and zero-mean. That is, the values of the feature vectors in the sets P, Q are assumed to be distributed in a conventional Gaussian distribution and are shifted to have a mean value of zero. Two Gaussian, zero-mean distributions differ based only on their covariance matrix S, so the KL divergence simplifies to the Equation listed above. This simplified equation can be applied more quickly by the computer 105 than a conventional KL divergence algorithm that can require additional calculations for specific probability density functions in a specified probability space. The distances rooted in the mean shift are captured via the Mahalanobis distances.

The first set P can be feature vectors 225 of a set of synthetic and real images 200, 220 without annotations of a landmark 210, and the set Q can be feature vectors 225 of a set of synthetic and real images 220 with annotations of a landmark 210. Thus, the KL divergence between P and Q characterizes the difference between the probability distribution of the feature vectors 225 of the images 220 that may include the landmark 210 and the feature vectors 225 of the images 200, 220 annotated with the landmark 210 associated with the memory allocation 215. When the KL divergence is below a difference threshold, the computer 105 can identify the landmark 210 in the feature vectors 225 of the synthetic images 220 without the annotations. The difference threshold can be a predetermined value based on inputting a plurality of test images 200 with landmarks 210 and identifying a maximum KL divergence at which the machine learning program 205 correctly identifies the landmark 210.

The computer 105 can input the KL divergence D_{KL} and the Mahalanobis distances d_{f}, dᵣ into a fully connected neural network to identify a landmark 210 in an input image 200. In a “fully connected” neural network, each neuron of a given layer is connected to each of the neurons in a subsequent layer. That is, the machine learning program 205 can include one or more fully connected layers to determine a probability that the collected images 200 include the landmark 210. That is, the output of the fully connected layers is a number between 0 and 1, where 0 indicates that images 200 do not include the landmark 210 and 1 indicates that the images 200 include the landmark 210, and values between 0 and 1 indicate a mathematical probability that the images 200 include the landmark 210. When the output of the fully connected layers is above a probability threshold, the computer 105 identifies the landmark 210 in the images 200, 220. The probability threshold is a value determined based on empirical testing of vehicles 101 collecting images 200 of predetermined landmarks 210 and comparing the output probability values to a visual inspection of the images 200. The probability threshold can be a minimum output of the machine learning program above which the computer 105 correctly identifies the landmarks 210 in the images 200 and correctly identifies no landmarks 210 in images 200 without landmarks 210. The probability threshold can be, e.g., 0.8. The fully connected layers can be trained with annotated images 200, 220 and landmarks 210 in memory allocations 215, as described below.

The computer 105 can collect a plurality of images 200 with a camera 110 while the vehicle 101 is traveling on a roadway. The computer 105 can generate a plurality of synthetic images 220 by applying one or more transformation programs to the collected images 200. The computer 105 can identify a covariance matrix S₀ and a mean feature vector 225 of the images 200, 220. The computer 105 can identify a forward Mahalanobis distance d_{f} between the mean feature vector 225 of the images 200, 220 and the feature vectors of each landmark 210 stored in the memory allocation 215 using an inverse covariance matrix S₁⁻¹ of the feature vectors of each landmark 210. The computer 105 can identify a reverse Mahalanobis distance dᵣ between the mean feature vector 225 of the feature vectors of each landmark 210 stored in the memory allocation 215 and the feature vectors of the collected images 200, 220 using the inverse covariance matrix S₀⁻¹ of the images 200, 220. The computer 105 can determine the KL divergence D_{KL} between the feature vector 225 of the image 200 for the respective inverse covariance matrix S₁⁻¹ of each memory allocation 215. The computer 105 can input the Mahalanobis distances d_{f}, dᵣ and the KL divergence for each landmark 210 to fully connected layers of a machine learning program that outputs a value between 0 and 1 indicating a probability that the images 200, 220 include the respective landmark 210. If the output from the fully connected layers is above a predetermined threshold, the computer 105 identifies the respective landmark 210 in the images 200, 220.

FIG. 4 is a diagram of an example machine learning program 400. The machine learning program 400 can be a deep neural network (DNN) 400 that could be trained to identify a physical landmark 210 from an input image 200. The DNN 400 can be a software program that can be loaded in memory and executed by a processor included in the infrastructure server 135, for example. The DNN 400 can include n input nodes 405, each accepting a set of inputs i (i.e., each set of inputs i can include one or more inputs X). The DNN 400 can include m output nodes (where m and n may be, but typically are not, a same natural number) provide sets of outputs o₁ . . . oₘ. The DNN 400 includes a plurality of layers, including a number k of hidden layers, each layer including one or more nodes 405. The nodes 405 are sometimes referred to as artificial neurons 405, because they are designed to emulate biological, e.g., human, neurons. The neuron block 410 illustrates inputs to and processing in an example artificial neuron 405i. A set of inputs X₁ . . . Xᵣ to each neuron 405 are each multiplied by respective weights wᵢ₁ . . . wᵢᵣ, the weighted inputs then being summed in input function Σ to provide, possibly adjusted by a bias bᵢ, net input aᵢ, which is then provided to activation function ƒ, which in turn provides neuron 405i output Yᵢ. The activation function ƒ can be a variety of suitable functions, typically selected based on empirical analysis. As illustrated by the arrows in FIG. 4, neuron 405 outputs can then be provided for inclusion in a set of inputs to one or more neurons 405 in a next layer.

The DNN 400 can be trained to accept as input data, e.g., synthetic images 220 from a plurality of transformation programs that input ambient features to a reference image 200, and to output one or more parameters for identifying a landmark 210. For example, the DNN 400 could be trained to output an identification of a building, an infrastructure element, etc.

That is, the DNN 400 can be trained with ground truth data, i.e., data about a real-world condition or state. Weights w can be initialized by using a Gaussian distribution, for example, and a bias b for each node 405 can be set to zero. Training the DNN 400 can including updating weights and biases via conventional techniques such as back-propagation with optimizations.

A set of weights w for a node 405 together are a weight vector for the node 405. Weight vectors for respective nodes 405 in a same layer of the DNN 400 can be combined to form a weight matrix for the layer. Bias values b for respective nodes 405 in a same layer of the DNN 400 can be combined to form a bias vector for the layer. The weight matrix for each layer and bias vector for each layer can then be used in the trained DNN 400.

In the present context, the ground truth data used to train the DNN 400 could include annotations identifying the landmarks 210 in the synthetic images 220. For example, a sensor can collect a plurality of images 200 that can be annotated and then be labeled for training the DNN 400, i.e., tags can be specified identifying the landmarks 210, such as just described, in the images 200. As described above, the images 200 can be input to a plurality of transformation programs to generate the synthetic images 220 while retaining the annotations of the landmarks 210. The DNN 400 can then be trained to output data values that correlate to the landmarks 210, and the output data values can be compared to the annotations to identify a difference, i.e., a cost function of the output data values and the input annotated images. The weights w and biases b can be adjusted to reduce the output of the cost function, i.e., to minimize the difference between the output data values and the input annotated images. When the cost function is minimized, the server 125 can determine that the DNN 400 is trained.

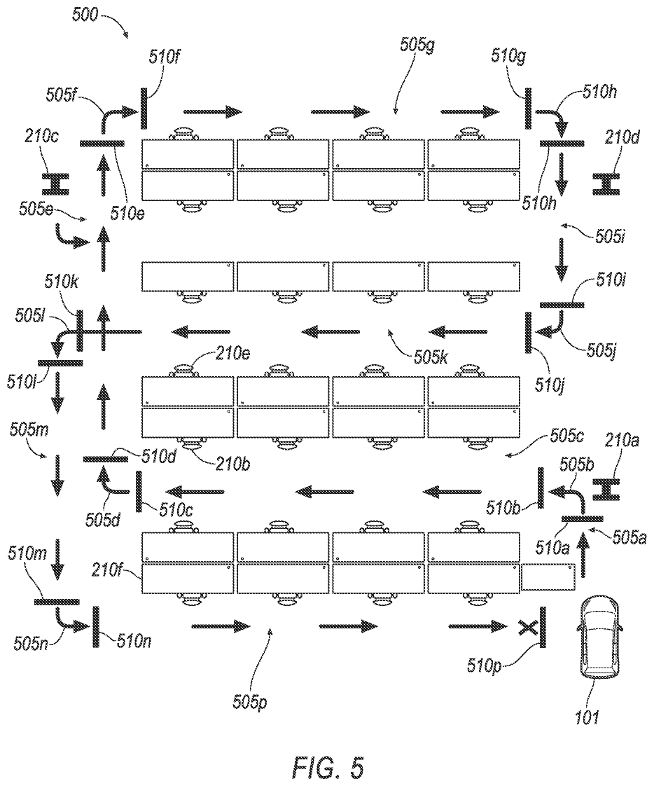

FIG. 5 is a view of an example vehicle 101 moving along a route 500. A “route” 500 is a path from an origin to a destination that the vehicle 101 follows to reach the destination. The route 500 can be a path generated from a path planning algorithm, e.g., a path polynomial. The path planning algorithm is programming of the computer 105 that generates a path for the vehicle 101 as the vehicle 101 moves from an origin to a destination. The path planning algorithm can be stored in a memory of the computer 105. The path planning algorithm can be, e.g., a navigational algorithm that generates location coordinates for the vehicle 101 over time. As an example, the path planning algorithm can determine the path with a path polynomial. The path polynomial p(x) is a model that predicts the path as a line traced by a polynomial equation. The path polynomial p(x) predicts the path for a predetermined upcoming distance x, by determining a lateral coordinate p, e.g., measured in meters:

p(x)=a₀+a₁x+a₂x²+a₃x³ (3)

where a₀ an offset, i.e., a lateral distance between the path and a center line of the vehicle 101 at the upcoming distance x, a₁ is a heading angle of the path, a₂ is the curvature of the path, and a₃ is the curvature rate of the path. In the present context, the “upcoming distance” x is a predetermined longitudinal distance in front of the vehicle 101 from a front bumper of the vehicle 101 at which the sensors 110 collect data and the computer 105 predicts the path. The upcoming distance x can be determined based on, e.g., a current speed of the vehicle 101, a predetermined time threshold, determined based on empirical simulation data, a detection range of the sensors 110, etc. The time threshold can be, e.g., 1 second. The path polynomial can include one or more Bezier curves, i.e., polynomial functions that each represent a disjoint subset of points representing the path, and that taken together, represent the entire set of points representing the path. Bezier curves can be constrained to be continuously differentiable and have constraints or limits on the permitted derivatives, e.g. limits on the rates of change, with no discontinuities. Bezier curves can also be constrained to match derivatives with other Bezier curves at boundaries, providing smooth transitions between subsets. Constraints on Bezier curves can make a vehicle path polynomial a steerable path polynomial by limiting the rates of longitudinal and lateral accelerations required to pilot a vehicle along the vehicle path polynomial, where braking torque and powertrain torque are applied as positive and negative longitudinal accelerations and clockwise and counter clockwise steering torque are applied as left and right lateral accelerations. By determining lateral and longitudinal accelerations to achieve predetermined target values within predetermined constraints within predetermined numbers of time periods, the vehicle path polynomial can be constrained to provide a vehicle path polynomial can be operated upon by the computer 105 without exceeding limits on lateral and longitudinal accelerations.

The computer 105 can plan actuation of one or more components 115 based on the route 500. That is, the computer 105 can actuate at least one of a propulsion, a steering, and/or a brake to move the vehicle 101 along the route 500. The computer 105 can actuate the components 115 to, e.g., turn the vehicle 101 to the left, turn the vehicle 101 to the right, maintain forward motion, etc. The route 500 includes a plurality of portions 505a-505p (collectively, portions 505). The portions 505 are indicated by arrows between respective boundaries 510a-510p (collectively, boundaries 510), the arrows indicating the direction of the route 500 that the vehicle 101 follows. Each portion 505 can be assigned a single “maneuver,” i.e., a trajectory defined by a path and respective velocities and/or accelerations at points on the path, that the vehicle 101 follows. The maneuver can start at one of the boundaries 510 and end at a successive boundary 510. The maneuver can be, e.g., a left turn, a right turn, a straight path, etc. The computer 105 can actuate components 115 to perform the maneuver to follow the route 500. For example, the maneuver assigned to the portion 505a can be a straight path to the boundary 510a.

The route 500 can pass by one or more landmarks 210a-210f (collectively, landmarks 210) as shown in FIG. 5. As described above, the landmarks 210 can be physical structures, e.g., infrastructure elements, buildings, road signs, etc. In FIG. 5, the landmarks 210 can be, e.g., portions of buildings, road signs, public works of art, portions of infrastructure elements, etc. For example, the landmark 210a can be an infrastructure element (e.g., a utility pole), the landmark 210b can be a front portion of a building, the landmark 210c can be another infrastructure element, the landmark 210d can be another infrastructure element, the landmark 210e can be a front portion of another building, and the landmark 210f can be a side portion of another building. The computer 105 can identify landmarks 210 that are the closest landmarks 210 to the route 500 (i.e., having a smallest Euclidian (i.e., straight-line) distance from the route 500) than other landmarks 210 in a geographic area. Prior to embarking on the route 500, the computer 105 can identify the landmarks 210 along the route 500, e.g., from geographic data from the server 125. While the vehicle 101 is traveling along the route 500, the computer 105 can actuate a camera 110 to collect images 200 of an environment around the vehicle 101. Upon collecting the images 200, the computer 105 can input the images 200 to the machine learning program 205 described above to identify landmarks 210 in the images 200. Upon identifying one of the landmarks 210 in one of the images 200, the computer 105 can actuate one or more components 115, as described below, to perform the maneuver assigned to the landmark 210 to follow the route 500.

The computer 105 can assign specific maneuvers, i.e., one or more specific actuations of the components 115, based on the portion 505 of the route 500 closest to the identified landmarks 210. For example, as shown in FIG. 5, at a first landmark 210a, the portion 505a of the route 500 turns to the left relative to forward motion of the vehicle 101. Prior to embarking on the route 500, the computer 105 can plan to turn the vehicle 101 to the left upon collecting an image 200 including the first landmark 210a, as described above. The computer 105 can identify a second landmark 210b at which the portion 505c the route 500 is a straight path and an upcoming portion 505d is a right turn. That is, upon identifying the landmark 210b, the computer 105 can actuate the components 115 to leave the straight path of the portion 505c, pass the boundary 510c, and begin the right turn of the portion 505d.

The computer 105 can generate a table of maneuvers for each identified landmark 210, an example of which is shown in Table 1:

TABLE 1
List of Maneuvers

| Landmark | Maneuver |
|---|---|
| 210a | Left Turn |
| 210b | Right Turn |
| 210c | Right Turn |
| 210d | Straight Path |
| 210e | Left Turn |
| 210f | Right Turn |

The computer 105 can determine whether the vehicle 101 has arrived at the destination. For example, the computer 105 can compare a current location of the vehicle 101 to the path polynomial defining the route 500. When the predicted upcoming distance x of the path polynomial is below a threshold (such as an average length of the vehicle 101, e.g., 2 meters), the computer 105 can determine that the vehicle 101 has arrived at the destination. Additionally or alternatively, the computer 105 can compare geo-coordinate data of a location of the vehicle 101 to geo-coordinate data of the destination. If a distance between the location of the vehicle 101 and the geo-coordinates of the destination is below the threshold (e.g., 2 meters as described above), the computer 105 can determine that the vehicle has arrived at the destination. Yet additionally or alternatively, the computer 105 can identify a landmark 210 at the destination and determine that the vehicle 101 has arrived at the destination upon identifying the landmark 210.

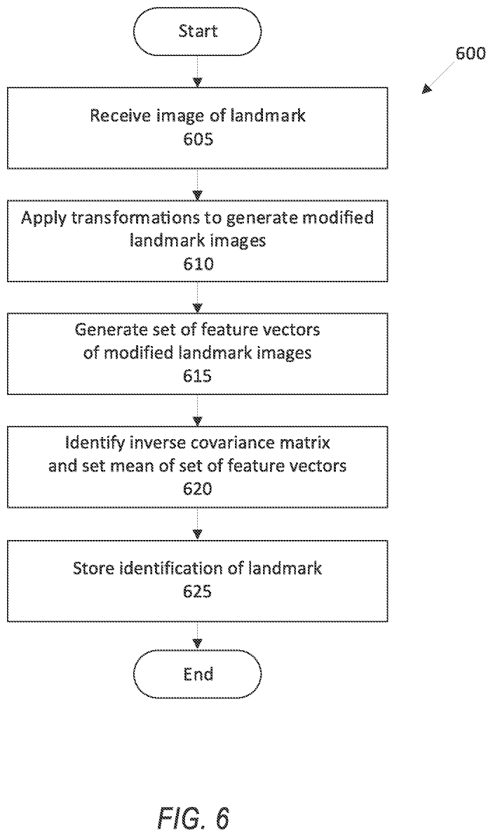

FIG. 6 is a diagram of an example process 600 for generating a plurality of memories 215 of landmarks 210. The process 600 begins in a block 605, in which a server 125 receives a reference image 200 including a landmark 210. The reference image 200 can be, e.g., an image 200 collected by a sensor 110 of a vehicle 101, as described above. The reference image 200 can include an annotation of a landmark 210.

Next, in a block 610, the server 125 applies one or more transformation programs to generate synthetic images 220, each synthetic image 220 including at least one ambient feature. As described above, the transformation programs are programming of the server 125 that incorporates an ambient feature (such as a change in lighting or a change in viewing angle, a time of day, seasonal variations, weather condition such a rain or clouds, etc.) into a copy of the reference image 200 to generate the synthetic image 220. A plurality of transformation programs can each insert a respective ambient feature to a copy of the reference image 200 to generate a set of synthetic images 220 with different ambient features. The synthetic images 220 thus can provide different scenarios for the machine learning program 205 than the reference image 200 alone can. The synthetic images 220 can preserve to annotation of the landmark 210 of the reference image 200.

Next, in a block 615, the server 125 generates a feature vector 225 for each synthetic image 220. As described above, the server 125 can input the synthetic image 220 to a machine learning program 205 to generate the feature vector 225. The feature vector 225 is a 1-dimensional array of values that encode information from the 2-dimensional synthetic image 220, as described above.

Next, in a block 620, the server 125 identifies a mean feature vector 225 and an inverse covariance matrix of the population of feature vectors 225 of the synthetic images 220 as described above. The server 125 can identify a mean and/or an inverse covariance of the feature vectors 225 to determine a statistical distance and/or a probability distribution difference, as described below.

Next, in a block 625, the server 125 stores the mean feature vector 225 and the inverse covariance matrix S in a memory allocation 215. The memory allocation 215 can be an allocation of memory in the server 125 assigned to the landmark 210. The memory allocation 215 can include the mean and/or the inverse covariance matrix of the feature vectors 225 of the synthetic images 220 including the landmark 210. Following the block 625, the process 600 ends.

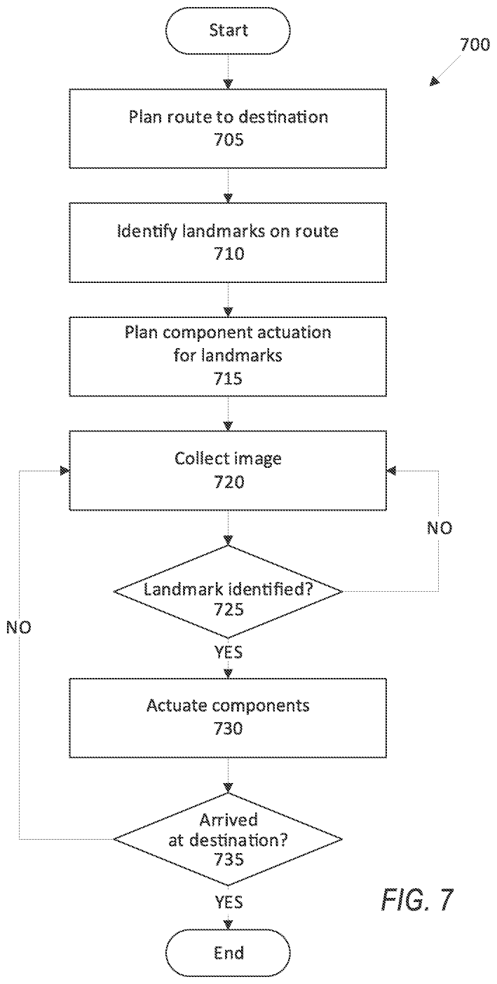

FIG. 7 is a block diagram of an example process 700 for operating a vehicle 101. The process 700 begins in a block 705 in which a computer 105 in the vehicle 101 plans a route 500 from an origin to a destination. As described above, the route 500 is a path from an origin to a destination that the vehicle 101 follows to reach the destination. The computer 105 can identify the path with a path polynomial, as described above.

Next, in a block 710, the computer 105 identifies one or more landmarks 210 along the route 500. The computer 105 can request a high-resolution map from the server 125 that includes identifications of landmarks 210 in a geographic area including the route 500. The computer 105 can identify landmarks 210 from the map that are on or near the route 500.

Next, in a block 715, the computer 105 plans actuation of one or more components 115 of the vehicle 101 based on the landmarks 210. As described above, the landmarks 210 may be located at portions 505 of the route 500 where a change in a trajectory of the vehicle 101, e.g., a left turn, a right turn, etc., may be performed to remain on the route 500. The computer 105 can plan actuation of the components 115 upon collecting an image 200 that includes the landmark 210 while traveling along the route 500.

Next, in a block 720, the computer 105 actuates one or more sensors 110 to collect images 200 of an environment around the vehicle 101 as the vehicle 101 moves along the route 500. For example, the computer 105 can actuate a camera 110 to collect the images 200.

Next, in a block 725, the computer 105 determines whether one of the images 200 includes an identified landmark 210. As described above, the computer 105 can input the images 200 into a machine learning program 205 that identifies the landmark 210. That is, the machine learning program 205 can identify a similarity measure between a feature vector 235 of the input image 200 and a reference feature vector 225 of the landmark 210 transmitted by the server 125 over the network 120 from a memory allocation 215 of the server 125. Alternatively, a memory of the computer 105 can store the memory allocations 215 of the landmarks 210. The similarity measure can be a probability distribution difference or a statistical distance, such as a Mahalanobis distance or a KL divergence. The machine learning program 205 can output a probability that the images 200 include the landmark 210. When the probability is above a predetermined threshold, the machine learning program 205 can output an identification of the landmark 210. If the computer 105 identifies a landmark 210, the process 700 continues in a block 730. Otherwise, the process 700 returns to the block 720 to collect more images 200.

In the block 730, the computer 105 actuates the components 115 according to the planned actuation assigned to the identified landmark 210. As described above, the computer 105 can actuate the components 115 to follow the route 500 upon identifying the landmark 210. For example, upon identifying one of the landmarks 210, the computer 105 can determine that the planned actuation is a left turn, and the computer 105 can actuate a propulsion, a brake, and a steering to perform the left turn.

Next, in a block 735, the computer 105 determines whether the vehicle 101 has arrived at the destination at the end of the route 500. The computer 105 can collect geo-coordinate data of a location of the vehicle 101 and compare the location of the vehicle 101 to the geo-coordinates of the destination. Alternatively or additionally, the computer 105 can identify a landmark 210 at the destination to determine that the vehicle 101 has arrived at the destination. If the computer 105 determines that the vehicle 101 has not arrived at the destination at the end of the route 500, the process 700 returns to the block 720 to collect more images 200. Otherwise, the process 700 ends.

Computing devices discussed herein, including the computer 105, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 600, one or more of the steps could be omitted, or the steps could be executed in a different order than shown in FIG. 6. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

The adjectives “first” and “second” are used throughout this document as identifiers and are not intended to signify importance or order.

What is claimed is:

1. A system, comprising a computer including a processor and a memory, the memory storing instructions executable by the processor to:
receive an image including a physical landmark;
output a plurality of synthetic images, wherein each synthetic image is generated by simulating at least one ambient feature in the received image;
generate respective feature vectors for each of the plurality of synthetic images; and
actuate one or more vehicle components upon identifying the physical landmark in a second received image based on a similarity measure between the feature vectors of the synthetic images and a feature vector of the second received image, the similarity measure being one of a probability distribution difference or a statistical distance.

2. The system of claim 1, wherein the instructions further include instructions to generate a route for a vehicle, to identify one or more physical landmarks along the route, and to plan actuation of the one or more vehicle components based on the identified one or more physical landmarks.

3. The system of claim 2, wherein the instructions further include instructions to, while the vehicle is traveling along the route, collect the second received image with a camera, to identify the physical landmark in the second received image, and to actuate the one or more vehicle components based on the planned actuation based on the identified one or more physical landmarks.

4. The system of claim 2, wherein the instructions further include instructions to assign a maneuver to each identified physical landmark on the route, the maneuver being one of a left turn, a right turn, or a straight path.

5. The system of claim 1, wherein the instructions further include instructions to identify a plurality of feature vectors associated with the physical landmark, and to identify the similarity measure of the feature vectors.

6. The system of claim 5, wherein the instructions further include instructions to identify the physical landmark when the similarity measure of a first plurality of the feature vectors is above a threshold and to identify a second physical landmark based when the similarity measure of a second plurality of the feature vectors is above the threshold.

7. The system of claim 1, wherein the instructions further include instructions to identify a similarity measure between a mean feature vector of the synthetic images and feature vectors of a plurality of received images and to identify the physical landmark when the similarity measure is above a threshold.

8. The system of claim 1, wherein the statistical distance is a Mahalanobis distance.

9. The system of claim 1, wherein the probability distribution difference is a KL divergence.

10. The system of claim 1, wherein the ambient feature is one of an insolation, precipitation, cloudiness, an amount of traffic, or a change in viewing angle.

11. The system of claim 1, wherein the instructions further include instructions to generate a covariance matrix of the feature vectors of the plurality of synthetic images, to generate an inverse covariance matrix that is a matrix inverse of the covariance matrix, and to determine the similarity measure based on at least one of the covariance matrix or the inverse covariance matrix.

12. The system of claim 1, wherein the instructions further include instructions to generate the feature vectors of the plurality of synthetic images with a machine learning program.

13. A method, comprising:
receiving an image including a physical landmark;
outputting a plurality of synthetic images, wherein each synthetic image is generated by simulating at least one ambient feature in the received image;
generating respective feature vectors for each of the plurality of synthetic images;
and
actuating one or more vehicle components upon identifying the physical landmark in a second received image based on a similarity measure between the feature vectors of the synthetic images and a feature vector of the second received image, the similarity measure being one of a probability distribution difference or a statistical distance.

14. The method of claim 13, further comprising generating a route for a vehicle, to identify one or more physical landmarks along the route and planning actuation of the one or more vehicle components based on the identified physical landmarks.

15. The method of claim 14, further comprising, while the vehicle is traveling along the route, collecting the second received image with a camera, identifying the physical landmark in the second received image, and actuating the one or more vehicle components based on the planned actuation associated with the physical landmark.

16. The method of claim 14, further comprising assigning a maneuver with each identified physical landmark on the route, the maneuver being one of a left turn, a right turn, or a straight path.

17. The method of claim 13, further comprising identifying a similarity measure between a mean feature vector of the synthetic images and feature vectors of a plurality of received images and identifying the physical landmark when the similarity measure is above a threshold.

18. The method of claim 13, wherein the ambient feature is one of an insolation, precipitation, cloudiness, an amount of traffic, or a change in viewing angle.

19. The method of claim 13, further comprising generating a covariance matrix of the feature vectors of the plurality of synthetic images, generating an inverse covariance matrix that is a matrix inverse of the covariance matrix, and to determine the similarity measure based on at least one of the covariance matrix or the inverse covariance matrix.

20. The method of claim 13, further comprising generating the feature vectors of the plurality of synthetic images with a machine learning program.
